(19) United States
(12) Patent Application Publication
(10) Pub. No.: US 2017/0252872 A1
(43) Pub. Date: Sep. 7, 2017

(54) METHOD FOR BRAZING AND USE OF A BRAZING FOIL FOR INDUCTION BRAZING

(71) Applicant: Vacuumschmelze GmbH & Co. KG, Hanau (DE)

(72) Inventor: Thomas HARTMANN, Altenstadt (DE)

(21) Appl. No.: 15/508,769

(22) PCT Filed: Aug. 18, 2015
(86) PCT No.: PCT/EP2015/068898

§ 371 Date: Mar. 3, 2017

(30) Foreign Application Priority Data
Sep. 5, 2014 (DE) 10 2014 112 831.1

(51) Int. Cl. B23K 35/22; B23K 1/002; F16L 41/08; C22C 19/07; B32B 15/01; B29C 65/78; C22C 19/05; C22C 45/00; F16L 41/02

(52) U.S. Cl. CPC B23K 35/22; C22C 45/008; B23K 1/002; F16L 41/084; F16L 41/026; B32B 15/01; B29C 65/7847; C22C 19/05; C22C 19/07; B23K 2201/04

(57) ABSTRACT

A method for brazing is provided, in which an amorphous or partially amorphous brazing foil, having a composition with a metalloid content of 10 to 30 at. %, is arranged at a joining point of two or more parts. The brazing foil is in the form of a wound ring-shaped strip which has a short-circuited current path between at least two layers lying one on top of the other. The brazing foil inductively heated, melted and a brazed connection of the parts is produced.

This U.S. national phase patent application claims priority to international patent application no. PCT/EP2015/068898, filed Aug. 18, 2015, which claims priority to German patent application no. 10 2014 112 831.1, filed Sep. 5, 2014, the entire contents of which are incorporated herein by reference.

### TECHNICAL FIELD

Method for brazing and use of a brazing foil for induction brazing

### BACKGROUND

The invention relates to a method for brazing and the use of a brazing foil for induction brazing.

Soldering is a method of joining metallic or ceramic parts using a molten additional substance which is described as solder. The melting temperature of the solder is below that of the base substances of the parts to be joined. These parts are wetted without being melted.

A distinction is made between soft solders and hard solders or brazes depending on the processing temperature of the solder. Soft solders are processed at temperatures below 450° C. and hard solders or brazes on the other hand at temperatures above 450° C. Hard solders or brazes are used in applications in which a high mechanical strength of the solder joint and/or a high mechanical strength at elevated operating temperatures is/are desired.

A special case of brazing is high temperature soldering. A high temperature solder has a liquidus temperature above 900° C. and is generally used for flux-free soldering in an oxygen-free processing atmosphere, such as in a vacuum or an inert gas. Besides increased strength properties of the solder joint, high temperature solders can also have increased corrosion resistance. In the case of Ni-, Co- and Fe-based solder materials this corrosion resistance can be increased by adding chromium.

For brazing, brazes or brazing alloys based on Al, Mg, Pd, Au, Ag, Cu, Co and Ni are primarily used, as described, e.g., in DIN EN ISO 17672 “Brazing—Filler metals”. Solders based on Al, Mg, Pd, Au, Ag and Cu are used in crystalline form as rolled foils, bars, wires and shaped parts produced from them such as for example rings bent from wire, or discs stamped from foils.

Brazes can also be used as solder powder, which is produced for example with an atomisation process, or in the form of solder pastes, in which the atomised powder is mixed with binders and solvents.

Brazes from the alloy group of Ni, Co or Fe solders, in the same way as also some Cu solders, have, for the purpose of lowering the melting point of the alloy matrix, a certain proportion of elements with a great melting-point-lowering effect, such as for example boron, phosphorus, silicon and carbon, which are added to the solder alloys in contents of more than 10 at. %. These elements are also described as metalloids and have the subsidiary effect that corresponding solder alloys in crystalline state are brittle and cannot be reshaped very well.

The hard solder or braze is brought between the components to be joined, or placed against them. The hard solder or braze and the parts are heated to a temperature (working temperature of the solder) which is above the liquidus temperature of the hard solder or braze and below the melting temperature of the components. The solder or braze melts, wets these components and fills capillary gaps. After the solder has solidified, a material-bonding joint is produced. In the majority of joints, the bond is produced based on cohesion forces in a very small zone in the contact region between the solder or braze and the base substance. The bond is due to atoms of the solder and of the base substance diffusing into each other. The elements used form mixed crystals, eutectics or intermetallic phases.

The parts can be heated for example in a furnace in a vacuum or an inert gas, wherein all the parts are heated to the soldering temperature. Alternatively, a selective heating method can be used, in which a local heating of the joining point is achieved. Examples of selective heating methods are flame soldering, beam soldering and induction brazing. In the case of induction brazing, a magnetic alternating field is coupled in a contactless way into the solder material, wherein the heat energy is produced directly in the solder material to be heated.

It is desirable to produce a method for brazing, with which a reliable soldered joint can also be produced in a selective heating process.

### SUMMARY

It is thus an object to provide a method for brazing, with which a reliable soldered joint can also be produced from an alloy with a higher metalloid content with a selective heating method.

This object is achieved by means of a method for brazing having the following steps: An amorphous or nanocrystalline brazing foil with a composition having a metalloid content of 10 to 30 at. % is disposed at a joining point or joining position or junction of two or more parts. The brazing foil is in the form of a wound ring-shaped strip which has a short-circuited current path between at least two layers lying one of top of the other. The brazing foil is inductively heated, melted and a hard soldered or brazed connection of the parts is produced.

According to embodiments of the invention, the braze is inductively heated in the form of a foil with a short-circuited current path between two layers lying one of top of the other. The brazing foil is thus wound to form a ring-shaped strip, wherein two layers of the wound ring-shaped strip, lying one on top of the other, are in electrical contact, in order to produce the short-circuited current path between the layers. Through the short-circuited current path, the eddy currents required for the induction brazing process can be produced in the ring-shaped strip. The short-circuited current path in the ring-shaped strip thus facilitates the use of a brazing foil in induction brazing processes for brazes such as metalloid-containing and chromium-containing brazing foils which cannot be successfully used in other forms such as powder in induction brazing processes.

### BRIEF DESCRIPTION OF THE DRAWINGS

Exemplary embodiments are described in more detail below by reference to the drawings and examples.

FIG. 1a shows a top view of a part for induction brazing,

FIG. 1b shows a perspective view of the part,

FIG. 2a shows a top view of a structure for induction brazing,

FIG. 2b shows a sectional view of the structure for induction brazing,

Table 1 shows the composition of the steels under investigation.

Table 2 shows the composition of the metal powders under investigation.

Table 3 shows the composition of the amorphous foils under investigation.

Table 4 shows test results.

### DETAILED DESCRIPTION OF EXAMPLE EMBODIMENTS

The amorphous or partially amorphous brazing foil has a metalloid content of 10 to 30 at. %, the elements Si, B and P being metalloids. This metalloid content is used in order to set the liquidus temperature of the braze so that it is suited for brazing of steels for example. A braze with a metalloid content of 10 to 30 at. % cannot be formed, however, into a wire by means of processing methods such as drawing and beating, because it is too brittle for such reshaping methods. According to embodiments of the invention, the braze is used in the form of an amorphous or partially amorphous brazing foil, which can be produced for example with a rapid solidification technology, so that it can be disposed around the joining point as a ring-shaped strip.

Due to their small particle size, irrespectively of their composition, metal powders cannot be brought to melt in medium frequency induction fields and are not therefore suitable for such soldering tasks.

The term “amorphous” is understood to mean at least 50 vol. % amorphous material. In one exemplary embodiment the brazing foil has at least 80 vol. % amorphous material. The term “partially amorphous” is understood to mean 20 to 50 vol. % amorphous material.

The brazing foil is not therefore used in the form of a flat foil, like a closed planar ring, which is stamped or cut from the foil, but instead in the form of a coil with windings from a strip-form foil, wherein at least two of the windings of the coil are in electrical contact with each other in order to produce the short-circuited current path. The form of a wound ring-shaped strip is material-saving in comparison with a stamped-out ring, as few residues, or even zero residues, come from the foil in the production process.

The form of a wound ring-shaped strip can be arranged around the joining point between two or more parts and can thus be used to braze tubular parts to each other.

The number of windings can be selected in order to adjust the amount of braze. The amount of braze necessary for a certain application can vary and can for example depend on the gap between two parts which are to be soldered to each other. This amount can be provided by a corresponding number of windings in the ring-shaped strip.

The brazing foil is formed so that the performance transfer into the part to be soldered is optimised in such a way that it heats as quickly as—or more quickly than—typical base substances, but not more slowly. A slower heating of the solder material can result in the base substance being overheated or thermally overloaded, which can lead to undesirable coarse grain formation as well as impairing the technological properties such as strength and corrosion resistance. In order to be used in industrialised processes in an economically favourable manner, it should be possible to reach the melting point of the solder within a maximum of 30 seconds, for which heating rates of approximately 35K/sec are necessary. Since it is possible with the application form according to embodiments of the invention to effectively and quickly heat a solder material, the energy requirement decreases per solder point and the processing duration also decreases per solder point, which increases the viability of the soldering method.

A robust braze part in the form of a brazing foil is made available, which can be easily adapted to the amount of solder required for the respective joining point, and facilitates simple and unproblematic handling, and of which the production can be realised economically and cost-favourably.

In one embodiment, the brazing foil is firstly wound around the joining point and then a short-circuited current path is produced between at least two layers of the brazing foil lying one on top of the other. This embodiment can be used for example with large parts, and/or with parts on which a tubular braze part cannot be pushed.

In a further embodiment, a wound ring-shaped strip is firstly produced with a short-circuited current path between at least two layers of the brazing foil lying one on top of the other in order to produce a wound ring-shaped strip as a braze part and then the braze part is arranged around the joining point. This embodiment thus provides a braze part that can be used later. This embodiment can be used with smaller parts and/or tubular parts.

In one embodiment, a premanufactured wound ring-shaped strip with a short-circuited current path between two layers of the brazing foil lying one on top of the other can be provided and the premanufactured ring-shaped strip can be arranged at the joining point. This embodiment can be used both with smaller parts and/or tubular parts as well as in applications in which numerous parts of similar shapes are to be brazed.

The short-circuited current path between the layers of the wound ring-shaped strip is produced so that it remains at approximately 600-1200° C. until the ring-shaped strip melts. The contact can thus be realised by all common welding methods or by mechanical joining technologies such as for example crimping. Joining technologies that do not withstand temperatures above 400° C., such as for example some soft soldering or adhesive technologies, are not therefore suitable for this application.

The short-circuited current path can be produced for example by welding, spot welding, crimping, mechanical connection of at least two overlapping layers of the wound ring-shaped strip. The short-circuited current path can, however, also go through several, or all, layers of the wound ring-shaped strip.

The wound ring-shaped strip has more than one single winding because it has an overlap of at least two layers, in order that a short-circuited current path can be produced between at least two layers lying one on top of the other. In further exemplary embodiments, the wound ring-shaped strip has at least two windings. The closed current path can be produced in different ways in these exemplary embodiments.

In one embodiment, at least two adjacent windings are in electrical contact with each other.

In one embodiment all windings are short-circuited by means of a common electrical connection with each other. Alternatively, several, but not all, windings can be short-circuited by means of a common electrical connection with each other.

The heating of the brazing foil and the joining point can be carried out in a vacuum or an inert gas. A suitable inert gas can be an inert gas such as argon or a hydrogen-containing gas mixture such as Ar-4% H₂. A vacuum or an inert gas can be used to avoid an oxidation of the parts and/or the brazing foil.

The brazing foil and the joining point are locally heated using an induction brazing process, wherein an induction coil is disposed around the joining point and the ring-shaped strip of the brazing foil, and an alternating current can be supplied such that the induction coil generates a magnetic alternating field. The magnetic alternating field induces eddy currents in the ring-shaped strip which generate heat in the ring-shaped strip. In induction brazing, the magnetic alternating field is thus coupled in a contactless manner into the solder material. The short-circuited current path of the ring-shaped strip wound according to embodiments of the invention thereby helps to couple the magnetic alternating field into the braze of the ring-shaped strip, so that it melts reliably and quickly. The heat energy is thus generated directly in the solder material to be heated, i.e. in the wound ring-shaped strip. The induction coil can, however, also be arranged within the parts to be connected, as the magnetic field also acts outside of the induction coil.

The arrangement of the wound ring-shaped strip at the joining point can differ and can be adapted to the shape of the parts to be brazed. The wound ring-shaped strip does not have to have a circular cross-section. For example the ring-shaped strip can be rectangular, hexagonal, oval or non-uniform. The wound ring-shaped strip can be disposed between two or more parts, for example between pipes arranged one inside the other, in order to braze these to each other. The wound ring-shaped strip can also be disposed within or outside of these parts, provided that the ring-shaped strip is in contact with the joining point.

The brazing foil can be ductile in order that it can be reliably wound in order to produce the wound ring-shaped strip.

To produce a solder joint between parts to be connected, in one embodiment the brazing foil and the joining point are heated to a temperature above a liquidus temperature of the brazing foil and cooled, with a brazed connection or soldered joint thereby forming between the parts.

The brazing foil has a liquidus temperature and the parts a melting temperature which is higher than the liquidus temperature of the brazing foil. The parts can each be made of a chromium-containing stainless steel, like an austenitic stainless steel, or ferritic stainless steel, or a Ni alloy or a Co alloy. The liquidus temperature of the brazing foil can be between 900° C. and 1200° C., wherein the liquidus temperature can be adjusted through the metalloid content. The processing temperature, i.e. the temperature to which the brazing foil is heated, can be above the liquidus temperature, for example 50° C. above the liquidus temperature.

In a further embodiment the brazing foil has a metalloid content of 10 at. % to 25 at. %.

The brazing foil can have different chemical compositions. In one exemplary embodiment the brazing foil has at least one transition metal nickel, cobalt, iron or copper and a total content of boron and/or phosphorus and/or silicon in the range of from 10 to 30 at. %. The composition is as follows:

TM_{Ba1} M10-30 at. %.

To improve the technological properties, further transition metals or metals such as chromium, molybdenum, niobium, tantalum, vanadium, tungsten, aluminium, manganese, tin or zinc can be added to the base elements and metalloids in a total content of 0 to 30 at. %.

Furthermore the alloy can have typical impurities such as for example carbon, sulphur or titanium up to 2 at. %.

According to embodiments of the invention, the metalloid-containing brazing foil is in the form of a wound ring-shaped strip, which is modified through the targeted arrangement of short-circuited current paths between the foil layers such that it can be heated significantly better in induction heaters than in other presentation forms such as powder or paste of the same alloy composition.

The wound ring-shaped strip can be used for brazes from the alloy group of Ni, Co or Fe solders which, for the purpose of melting point reduction of the alloy matrix, have a certain proportion of elements with great melting-point-reducing effect such as boron, phosphorus, silicon and carbon. As these metalloids are dissolved only limitedly in Ni, Co or Fe alloys, brittle intermetallic compounds separate off during the crystal formation in the solidification of the melt, which then lead to the solidified melt being too brittle to be reshaped.

Due to the inherent brittleness and poor cold formability of these Si-, B- or P-containing solders, they cannot be processed by means of conventional hot and cold forming steps to form foils, strips or wires, but instead are available extensively only in semi-finished formats produced directly from the melt. These would be gas-atomised powders and application forms produced therefrom such as solder pastes or solder tapes, wherein the metal powders are mixed with organic binders and solvents. If such an alloy has a metalloid content of between 10 and 30 at. %, it is possible to produce it by means of a rapid solidification process in the form of ductile, at least partially amorphous foils.

The alloy composition of the high temperature Ni-, Co- or Fe-based brazes can also have a chromium content which is sufficiently high to protect the alloy from corrosive or oxidative effects. For example the Ni-, Co- or Fe-based brazes have at least 3 at. % chromium. For this reason, soldering methods are required that allow processing to be carried out in an extensively oxygen-free processing atmosphere in order: (a) to reduce the oxide layer of the substance in order to facilitate a wetting and flowing of the solder, and (b) to protect the materials used from further oxidation and scaling during the heat input. For this reason, such solders are mostly formed as furnace solders in an inert gas atmosphere or in a vacuum. Other selective heating forms such as flame soldering or beam soldering cannot easily be carried out in an inert gas atmosphere or in a vacuum. These methods are thus unsuitable for processing these high temperature solders.

Due to the form of the brazing foil as a wound ring-shaped strip with a short-circuited current path, a method for brazing with high temperature solders is provided, with which a reliable soldered joint can be produced from a high temperature solder of a (Ni, Co, Fe)—Cr—(Si, B, P) alloy by means of an inductive heating method. Components to be soldered which cannot be soldered in a furnace due to their size, structural form or complexity, or if not all parts of a component can be heated, can also be brazed.

Some copper-based brazes have, for the purpose of melting point reduction of the alloy matrix, a certain proportion of at least one element such as phosphorus with great melting-point-reducing effect in contents of more than 10 at. %. Some of these copper-based brazes can be produced as wire. According embodiments of to the invention, they are also provided in the form of a wound ring-shaped strip which has a short-circuited current path between two layers lying one on top of the other and are inductively heated in order to connect parts over a brazed joint.

According to embodiments of the invention the use of an amorphous or partially amorphous brazing foil with a metalloid content of 10 to 30 at. % is further provided for induction brazing, wherein the brazing foil has the form of a wound ring-shaped strip which has a short-circuited current path between two layers lying one on top of the other.

In one embodiment, a Ni-, Fe- or Co-based brazing foil is used in an induction brazing process. In one embodiment the Ni-, Fe- or Co-based brazing foil has a chromium content of at least 3 at. %. This induction brazing process can also be carried out in a vacuum or in an inert gas in order to avoid oxidation of the brazing foil.

In one embodiment a copper-based brazing foil is used in an induction brazing process.

Parts of a heat exchanger or an exhaust gas system or a metallic particulate filter or catalyst or a fuel line can be brazed using an induction brazing process, wherein the brazing foil is arranged at a joining point of the parts of a heat exchanger, a metallic catalyst or an exhaust gas system or a metallic particulate filter or a fuel line, and the parts are brazed using an induction brazing process.

An application form of a metalloid-containing solder alloy is thus provided, with which these alloys can be heated in induction fields and are therefore suitable for induction brazing. The application form according to embodiments of the invention of a wound ring-shaped strip with a short-circuited current path between two layers, lying one on top of the other, of the ring-shaped strip has different technological, economic and health and safety at work advantages in comparison with other application forms.

In order to produce corrosion-resistant high temperature soldered joints with an induction brazing method, it is desirable for it also to be possible for chromium-containing solder materials to be processed with this joining technology. Applications for such induction brazing are for example joint connections on fuel lines and exhaust gas systems in the automotive field, on pipelines of the chemical industry or joining points in the hot gas zone of propulsion units, wherein generally at least one of the parts to be joined is a tubular, thin-walled component. For this, chromium-containing brazes such as described for example in the group of nickel brazes in DIN EN ISO 17672 are inductively heated.

For induction brazing in industrial practice mainly chromium-free copper or silver solders from conventionally produced crystalline substances in the form of wire rings or wire portions are applied at the solder gap, or as a strip or part in the solder gap. The soldering process takes place, optionally with the addition of suitable flux media at temperatures of 600° C. to 1000° C. The process duration is typically a few minutes, wherein the solder temperature is reached after approximately 10 to 60 seconds. Solder pastes of these chromium-free Cu- or Ag-alloys can also be used for inductively heated soldering tasks. These are associated, however, with longer process times than those of comparable solid solders, as solder powder cannot be heated by the induction field alone, but instead can only be brought to melt through radiation from the inductively heated base substance. An undesirable overheating of the base substance of, at times, several hundred degrees Celsius is the rule here. For this reason, powder-based solder materials can be used for induction brazing if the melting temperature of the solder is substantially below the temperature at which the coarsening of particles of the base substance begins.

The silver solder Ag 156 (DIN EN ISO 17672) has a melting point of 660° C. and can thus be used for induction brazing of stainless steels, wherein the formation of coarser particles typically begins at 1050° C. If a low-melting chromium-containing nickel solder is used, such as for example Ni 620 with a liquidus temperature of 1025° C., the base substance can be so greatly damaged by overheating that the technological properties are reduced and a proper use of the component is no longer possible.

Contrary to the opinion that chromium-containing nickel-based brazes are not suitable for induction brazing, it is ascertained according to embodiments of the invention that these chromium-containing nickel-based alloys can be used in induction brazing if they are in the form of a wound ring-shaped strip with a short-circuited current path.

It is ascertained that not every starting form of these chromium-containing solder materials can be inductively heated. Chromium-containing brazes in the form of powder and pastes cannot be adequately heated or cannot be heated at all. In the configuration according to embodiments of the invention, however, chromium-containing brazing foils can be heated. A possible reason for this observation is that the structural size of the solder powder particles of 50 to 150 μm is too small to produce a skin effect in medium frequency and high frequency alternating fields of the induction heating installations. Furthermore it is observed that the solder powders under investigation have a poor electrical conductivity.

In one embodiment a braze part is produced from a chromium-containing solder material which can be quickly heated in the medium frequency and high frequency induction fields.

For the brazing and high temperature soldering of steels, stainless steels, as well as Ni and Co alloys, above all Ag-, Cu-, Co- and Ni-based solders are used as described e.g. in DIN EN ISO 17672 “Brazing—Filler Metals”. Insofar as the joined component is exposed to a high corrosion load, only chromium-containing braze alloys are suitable as can be found in the group of nickel and cobalt solders of this standard. Furthermore chromium-containing nickel and iron solders, as described for example in U.S. Pat. No. 8,052,809 B2 or U.S. Pat. No. 7,392,930 B2, are also suitable. Such solder alloys contain a certain chromium content to improve the corrosion resistance as well as the elements silicon, boron and phosphorus, coming from the group of non-metal or semi-metals, in order to reduce the melting temperature. The processing temperatures of these solder materials are typically around 1000° C. to 1200° C. Due to the inherent brittleness and poorer cold formability of these Si, B or P containing solders, they cannot be processed by means of conventional heat and cold forming steps to form foils, strips or wires, but instead they are available extensively only in semi-finished formats produced directly from the melt. These would be gas atomised powders and application forms produced therefrom such as solder pastes or solder tapes, wherein the metal powder is mixed with organic binder and solvents. Besides the powder processed products, some of these solder alloys can also be produced with the process of rapid solidification as homogeneous, ductile, at least partially amorphous brazing foils in thicknesses of approximately 15-75 μm.

For soldering chromium-containing solder materials, soldering methods are suitable that allow work to be carried out in an extensively oxygen-free process atmosphere in order to reduce the chromium oxide layer of the substance in order to facilitate a wetting and flowing of the solder and in order to protect the substances used from further oxidation and scaling during the heat input.

For this reason such soldering processes are mostly carried out as furnace soldering processes in an inert gas atmosphere or in a vacuum. Some selective heating methods such as flame soldering or beam soldering cannot take place easily in an inert gas atmosphere or in a vacuum and are less suitable.

A selective heating method which can be combined with a highly effective protective gasification is inductive heating. In induction brazing a solder material is locally heated by means of contactless coupling of a magnetic alternating field. The heat energy is produced directly in the solder material to be heated. The devices used for this are the induction heaters. They produce, by means of a coil—the inductor—through which low frequency (1-70 kHz), medium frequency (70-500 kHz) or high frequency (0.5-1.5 MHz) alternating current flows, a magnetic alternating field that induces an electrical voltage in the solder material. The induced voltage leads to a current flowing in the solder material, the eddy current, which leads to a heating of the components according to Joule's law.

In the case of medium frequency and high frequency alternating voltages, the occurrence of the skin effect leads to these eddy currents being forced at work-piece areas close to the surface. The higher the frequency the greater is this effect. As the components in soldering processes must only be heated close to the surface, medium frequency and high frequency induction heaters are particularly well suited for soldering tasks.

Besides the effect of heating via the eddy current losses, heating can additionally take place in ferromagnetic materials via the re-magnetisation losses arising in the magnetic alternating field. This effect leads, however, only to the Curie temperature being reached, for example the Curie temperature T_{c} for steel is 650-750° C., for a heating of the component. If the component is to be soldered at higher temperatures, it is designed in terms of material and structure so that the induced current can produce the greatest eddy current losses possible in order to achieve a high level of efficiency.

The heat power can be controlled and reproduced well in induction brazing processes. Unlike in furnace soldering processes, it is not necessary to bring the whole component to a joining temperature. By adapting the inductor geometry to the component it is possible to heat exclusively small solder joint regions without thermally loading the rest of the component. Due to the high power, very short heating times of the solder points, for example of a few seconds, can be realised. The high power density of the method, coupled with the extremely short process times resulting therefrom, make it one of the most economical, industrially viable soldering methods.

The very short process time furthermore allows thermally sensitive base substances, with which a longer heat input can lead to changes in the microstructure, to be soldered without risk of impairment of the technological properties. This is particularly advantageous with high temperature soldering of steels or nickel based substances.

As the induction field penetrates a ceramic non-conductor without power loss, it is also possible to heat components that are located inside a ceramic protective tube. This is particularly advantageous in the case of brazing or high temperature soldering if an oxygen-free process atmosphere, such as in a vacuum or an inert gas is provided around the joining point in order to prevent an oxidation and scaling of the substances during the heat input. Induction brazing processes can therefore also be efficiently automated and can be easily integrated into industrial manufacturing processes.

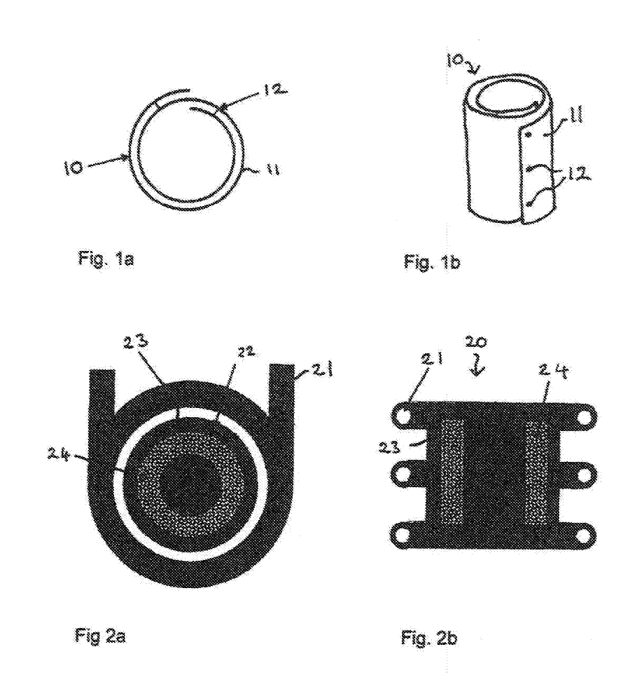

FIG. 1a shows a top view and FIG. 1b a perspective view of a part 10 for induction brazing. The part 10 is a wound ring-shaped strip and has a brazing foil 11 wound in multiple layers, which has an electrical contact through the layers at least at one point 12. The brazing foil 11 has a metalloid content of 10 to 30 at. % and is at least partially amorphous. The electrical contact 12 can be provided by welding, spot welding or a mechanical connection. The solder part 10 therefore has a short-circuited current path between two layers lying one on top of the other.

The wound ring-shaped strip shown in FIG. 1 has two windings. The wound ring-shaped strip can, however, have more than two windings or fewer than two full windings. At least two ends of a brazing foil should overlap so that a short-circuited current path can be produced between two layers lying one on top of the other. The layers can be in direct mechanical contact. However, they can also be spaced apart from each other and short-circuited through an interposed electrical connection with each other.

The soldering foil part 10, as shown in FIG. 1, is suitable for induction brazing and can be composed of a nickel, iron, cobalt or copper alloy, of which the composition of silicon and/or boron and/or phosphorus is in a total content of 10 at. % to 30 at. %, wherein the solder alloy is present as an amorphous or at least partially amorphous strip which is wound up to form a multi-layer ring-shaped strip core. A nickel, iron or cobalt alloy can further include chromium, for example at least 3 at. % chromium, in order to improve the corrosion resistance of the brazed or the solder joint.

To form the necessary eddy currents during induction brazing the two layers are in electrical contact with each other. As the foil layers can be insulated relative to each other for example by non-electrically-conductive layers such as silicon oxide or aluminium oxide, this electrical contact is ensured through suitable measures at least at one point. For example the oxide layer can be removed at one point and these exposed points of at least two layers electrically connected with each other.

The brazing foil is arranged around a joining point or position or junction between two or more parts. The brazing foil can be wound up and the short-circuited current path produced by an electrical connection between two layers of the brazing foil lying one on top of the other.

The wound ring-shaped strip can be produced as a single component, as shown in FIG. 1, and then arranged around the parts to be connected. Alternatively, the brazing foil can be wound onto one of the components to be soldered and the electrical contact then produced between two layers in order to produce the short-circuited current path.

The outer diameters of such ring-shaped strips are typically between 30 and 500 mm. The ring height or the width of the solder foils used is typically 1 mm to 20 mm.

The brazing foil and the joining point are heated, the braze of the wound ring-shaped strip is melted, the parts and the braze are cooled, thereby producing a brazed connection of the parts. The heating is carried out with an induction brazing process.

FIG. 2a shows a top view and FIG. 2b a cross-section of a structure of an induction heating installation 20. The induction heating installation 20 is for example of the brand Linn Elektronik HTG-1000, which has a maximum output power of 1.3 KW. This induction heating installation 20 is used with a working frequency of approximately 300 kHz. The system is operated with 90% output power for the tests described below.

The induction coil 21 has an inner diameter of 32 mm and a height of 40 mm. A ceramic coil pot 22 of boron nitride (da 29 mm, h 35 mm) has been coupled into this coil, having a circular recess 23 (da 25 mm, di 21 mm, h 15 mm) for receiving solder material 24. The solder material 24 was orientated in the middle and centrally relative to the inductor coil and heated in an insulated way without the addition of a further substance.

Tests on different chromium-containing braze materials are carried out in order to examine their melt behaviours in the induction field. Chromium-containing braze materials are advantageous for some applications, as they can improve the corrosion resistance of the soldered joint.

In Tables 1 to 3, the materials under investigation are described in more detail, wherein a distinction is made here between base substances/steels, solder powders and solder foils.

TABLE 1

| | Substance | Composition | | Ferro- |
|---|---|---|---|---|
| Material | name | (wt. %) | Dimensions | magnetism |
| S1 | 1.4301 | 72Fe—10Ni—18Cr | Tube | No |
| S2 | 1.4521 | 80Fe—18Cr—2Mo | Tube | Yes |

Table 1 shows the composition and form of the base substance, under investigation, of the parts to be joined. Tubular parts of steels 1.4301 and 1.4521 are examined.

TABLE 2

| | Substance | Composition | Particle | Melting | |
|---|---|---|---|---|---|
| Material | name | (wt. %) | size (μm) | point (° C.) | Ferromagnetism |
| P1 | Nickel | 100Ni | 5-20 | 1455 | Yes |
| P2 | FP613 | 60Ni—30Cr—4Si—6P | 50-150 | 1020 | No |
| P3 | TB5020 | 50Fe—15Ni—20Cr—2Mo—5Si—8P | 50-150 | 1100 | Yes |
| P4 | Ni650 | 71Ni—19Cr—10Si | 50-150 | 1135 | No |

In a first series of tests, brazes in powder form are investigated in order to ascertain whether chromium-containing brazes in powder form can be melted with an induction process and are therefore suited for induction brazing. Table 2 shows the composition of the powders investigated. Nickel, FP613, TB5020 and Ni650 are investigated.

TABLE 3

| | | | Foil | Melting | |
|---|---|---|---|---|---|
| | Substance | Composition | thickness | point | |
| Material | name | (wt. %) | (μm) | (° C.) | Ferromagnetism |
| F1a | VZ2177 | 67Ni—25Cr—6P—1.5Si—0.5B | 40 | 1040 | No |
| F1b | | | 25 | | |
| F1a | VZ2120 | 82.4Ni—3Fe—7Cr—4.5Si—3.1B | 50 | 1025 | No |
| F2b | | | 20 | | |
| F3 | VZ2150 | 73.4Ni—18.2Cr—7.3Si—1.2B | 30 | 1135 | No |

In a further series of tests, brazes in the form of at least partially amorphous ductile foils are investigated in order to ascertain whether chromium-containing brazing foils can be melted with an induction process and are thus suited for induction brazing. Table 3 shows the composition of the amorphous brazing foils under investigation. The brazing foils VZ2177, VZ2120 and VZ2150 by Vacuumschmelze GmbH & Co. KG are investigated.

TABLE 4

| | | Wall | | | Specimen temperature X | | | Heating | |
|---|---|---|---|---|---|---|---|---|---|
| | | thickness | Number of | Mass | reached after Y seconds | | | rate | |
| Test | Material | (mm) | windings | (g) | X = 50° C. | X = 600° C. | X = 1000° C. | (K/sec) | Melted |
| V1 | S1 | 2 | 1 | 13.6 | | 25 | 62 | 16.1 | — |
| V2 | S1 | 1 | 1 | 7.7 | | 9 | 40 | 25.0 | — |
| V3 | S2 | 2 | 1 | 13.0 | | 7 | 39 | 25.6 | — |
| V4 | S2 | 1 | 1 | 7.3 | | 4 | 15 | 66.7 | — |
| V5 | P1 | 1.5 | 1 | 6.6 | 50 | — | — | 0.5 | No |
| V6 | P2 | 1.5 | 1 | 6.2 | No heating possible. | | | 0 | No |
| V7 | P3 | 1.5 | 1 | 5.97 | 55 | — | — | 0.5 | No |
| V8 | P4 | 1.5 | 1 | 6.35 | No heating possible | | | 0 | No |
| V9 | F1a | 1.8 | 40 | 11.88 | | 9 | 28 | 35.7 | Yes |
| V10 | F1a | 1.35 | 32 | 9.58 | | 7 | 24 | 41.7 | Yes |
| V11 | F1a | 0.9 | 20 | 6.65 | | 4 | 11 | 90.9 | Yes |
| V12 | F1a | 0.45 | 10 | 3.37 | | 1 | 3 | 333.3 | Yes |
| V13 | F1a | 0.23 | 5 | 1.65 | | 1 | 2 | 500.0 | Yes |
| V14 | F1a | 0.09 | 2 | 0.65 | | 1 | 2 | 500.0 | Yes |
| V15 | F1a | 0.04 | 1.1 | 0.36 | | 1 | 2 | 500.0 | Yes |
| V16 | F3 | 0.7 | 20 | 4.14 | | 2 | 5 | 200.0 | Yes |
| V17 | F3 | 0.35 | 10 | 2.11 | | 1 | 2 | 500.0 | Yes |
| V18 | F2a | 0.84 | 20 | 5.55 | | 4 | 10 | 100.0 | Yes |
| V19 | F2a | 0.43 | 10 | 3.01 | | 3 | 5 | 200.0 | Yes |
| V20 | F1b | 0.05 | 2 | 0.33 | | | 2 | 500.0 | Yes |
| V21 | F1b | 0.025 | 1.1 | 0.16 | | | 2 | 500.0 | Yes |
| V22 | F2b | 0.46 | 20 | 3.01 | | 3 | 4 | 250.0 | Yes |
| V23 | F2b | 0.25 | 10 | 1.49 | | 1 | 2 | 500.0 | Yes |
| V24 | F1a | 0.3 | 2 | 0.85 | 420 | — | — | 0.1 | No |
| | | | (Insulated) | | | | | | |
| V25 | F1a | 0.04 | 0.9 | 0.32 | 300 | — | — | 0.2 | No |

The results of the tests are summarised in Table 4. Braze materials in the form of a wound ring-shaped strip of a brazing foil with a height of 13 mm and an outer diameter of 24.5 mm with a variable number of windings are provided.

The duration until different temperatures are reached with an inductor power of 90% is measured. The heating rate is calculated from this measured duration.

Firstly, it is determined how quickly austenitic and ferritic chromium steels can be heated in the induction heater provided. For this, pipe portions with 1 mm and 2 mm wall thickness of the steel substances 1.4301 and 1.4521 are heated to 1000° C.—See V1 to V4 of Table 1. Depending on the substance and dimensions or wall thickness, heating rates of 16 to 66 K/min are measured.

It is desirable that the braze can be heated with comparable heating rates or higher heating rates up to the melting point, in order to keep the thermal load of the base substances low and to keep the solder process short.

The tests V5 to V8 describe the investigations with different braze powders and nickel powder and show that, even with a test duration of 500 seconds, no significant heating of the solder material is reached. Melting of the powder cannot be achieved in any of the cases.

The tests V9 to V25 were carried out with amorphous brazing foils in the foil width 13 mm. Insofar as the strip was wound to form a closed ring having electrical contact between the strip layers—see tests V9 to V23 of Table 4—, the solder foil parts used exhibit a very good heating behaviour in the induction field and can be melted. Surprisingly, solder foil parts showed approximately 35% higher heating rates than the steels examined with comparable dimensions and weights. See in this connection test V9 in comparison with tests V1 and V3, and test V11 in comparison with tests V2 and V4. Heating rates of up to 500 K/s are measured.

A comparison between the tests V21 and V25 shows the functioning of the solder foil part, which is achieved by at least one full, electrically connected winding. An unclosed ring shape cannot be melted, as shown in test 25. In test 24, the layers of the wound ring-shaped strip are electrically insulated from each other. Test 24 shows that, even with multi-layer designs, the layers should be electrically contacted with each other in order to be able to melt the brazing foil. Without electrical contact between the strip layers, no noteworthy heating of the solder foil part takes place, and this ring-shaped strip is not therefore suitable for induction brazing.

Obviously, many modifications and variations of the present invention are possible in light of the above teachings and may be practiced otherwise than as specifically described while within the scope of the invention.

1. A method for brazing, having the following steps:
arranging an amorphous or partially amorphous brazing foil, having a composition with a metalloid content of 10 to 30 at. %, at a joining point of two or more parts, wherein the brazing foil is in the form of a wound ring-shaped strip which has a short-circuited current path between at least two layers lying one on top of the other,
inductive heating the brazing foil,
melting the brazing foil, and
producing a brazed connection of the parts.

2. A method according to claim 1,
wherein
firstly the brazing foil is wound around the joining point and then a short-circuited current path is produced between at least two layers of the brazing foil lying one on top of the other.

3. A method according to claim 1,
wherein
firstly a wound ring-shaped strip is produced with a short-circuited current path between two layers, lying one on top of the other, of the brazing foil, in order to produce a wound ring-shaped strip as a braze part, and then the braze part is arranged around the joining point.

4. A method according to claim 1,
wherein
a premanufactured wound ring-shaped strip with a short-circuited current path between two layers, lying one on top of the other, of the brazing foil is provided and the premanufactured ring-shaped strip is arranged at the joining point.

5. A method according to one claim 1,
wherein
the short-circuited current path is produced by welding, spot welding, crimping or a mechanical connection of at least two overlapping layers of the wound ring-shaped strip.

6. A method according to claim 1,
wherein
the wound ring-shaped strip has at least two windings.

7. A method according to claim 6,
wherein
at least two adjacent windings are in electrical contact with each other.

8. A method according to claim 6,
wherein
all windings are short-circuited by means of a common electrical connection with each other.

9. A method according to claim 6,
wherein
a plurality of windings are short-circuited by means of a common electrical connection with each other.

10. (canceled)

11. A method according to claim 1,
wherein
at least the brazing foil and the joining point are heated in a vacuum or an inert gas.

12. A method according to claim 1,
wherein
the brazing foil and the joining point are locally heated.

13. A method according to claim 1,
wherein
an induction coil is arranged around the joining point.

14. A method according to claim 13,
wherein
the parts are brazed using an induction brazing process.

15. A method according to claim 1,
wherein
the wound ring-shaped strip is arranged outside, inside or between two or more parts.

16. A method according to claim 1,
wherein
the brazing foil and the joining point are inductively heated to a temperature above a liquidus temperature of the brazing foil and are cooled, with a brazed joint thereby being formed between the parts.

17. A method according to claim 1,
wherein
the first part and the second part are each composed of a chromium-containing stainless steel, such as an austenitic stainless steel, or a Ni alloy or a Co alloy.

18. A method according to claim 1,
wherein
the brazing foil comprises an iron-, nickel- or cobalt-based brazing foil.

19. A method according to claim 18,
wherein
the brazing foil comprises at least 3 at. % chromium.

20. A method according to claim 1
wherein
the ductile brazing foil comprises a chromium-free brazing foil.

21. A method according to claim 1,
wherein
the brazing foil provided comprises a copper-based brazing foil.

22. A brazing foil for induction brazing,
wherein
the brazing foil is an amorphous or partially amorphous brazing foil with a metalloid content of 10 to 30 at. % and has the form of a wound ring-shaped strip which has a short-circuited current path between two layers lying one on top of the other.

23. A brazing foil according to claim 22,
wherein
the brazing foil comprises an iron-, nickel- or cobalt-based brazing foil.

24. A brazing foil according to claim 23,
wherein
the brazing foil comprises a chromium content of at least 3 at. %.

25. A brazing foil according to claim 22,
wherein
the brazing foil comprises a copper-based brazing foil.

26. A brazing foil according to claim 22,
wherein
the brazing foil is arranged at a joining point of parts of a heat exchanger, a metallic catalyst or an exhaust gas system or a metallic particulate filter or a fuel line, and the parts are brazed using an induction brazing process.

27. A method for induction brazing, having the following steps:
providing an amorphous or partially amorphous brazing foil with a metalloid content of 10 to 30 at. % and having the form of a wound ring-shaped strip which has a short-circuited current path between two layers lying one on top of the other, and
inductive heating the brazing foil.
